(19) United States
(12) Patent Application Publication
(10) Pub. No.: US 2010/0166947 A1
(43) Pub. Date: Jul. 1, 2010

(54) SUBSTRATE PROCESSING APPARATUS, DEPOSITION METHOD, AND ELECTRONIC DEVICE MANUFACTURING METHOD

(75) Inventor: Atsushi TAKEDA, Yokohama-shi (JP)

Correspondence Address: BUCHANAN, INGERSOLL & ROONEY PC, POST OFFICE BOX 1404, ALEXANDRIA, VA, 22313-1404, US

(73) Assignee: CANON ANELVA CORPORATION, Kawasaki-shi (JP)

(21) Appl. No.: 12/646,049

(22) Filed: Dec. 23, 2009

(30) Foreign Application Priority Data
Dec. 26, 2008 (JP) 2008-335156
Dec. 14, 2009 (JP) 2009-283428

(51) Int. Cl. B05D 3/02; G05D 23/19

(52) U.S. Cl. 427/58; 118/708; 427/314

(57) ABSTRACT

A substrate processing apparatus includes a heating unit which has a plurality of heaters used to heat a substrate in a first process chamber, a temperature line sensor configured to measure temperatures of the substrate heated by the heating unit while the substrate is conveyed from the first process chamber to a second process chamber, a re-heating unit which has a plurality of heaters used to re-heat the substrate in the second process chamber, and an output control unit which controls an output of the re-heat unit based on the measurement results of the temperature measurement units.

### BACKGROUND OF THE INVENTION

1. Field of the Invention

The present invention relates to a substrate processing apparatus, a deposition method, and a manufacturing method of an electronic device.

2. Description of the Related Art

It is important to accurately measure a process temperature in a deposition apparatus and to control a heating temperature upon achieving deposition with well-controlled film quality.

As a method of measuring the temperature of a heated substrate, an attempt is made to measure the temperature of a substrate by bringing a thermocouple into point contact with a substrate. With this measurement method, since the temperature of the substrate is measured while the thermocouple is in point contact with the substrate, it is difficult to stably maintain a constant contact state of the thermocouple, resulting in poor reproducibility of the measured temperature. When a substrate is heated by radiating infrared rays, since the substrate is nearly transparent within a broad range of an infrared region, heat is not transferred to the thermocouple only by heat conduction from the substrate, but the thermocouple itself may often be heated by a lamp heater. For this reason, it is difficult to accurately measure the temperature of the substrate using the thermocouple.

As one method of measuring the temperature of a substrate in a non-contact manner in vacuum, a method of measuring an irradiance intensity from a substrate in an infrared region using an infrared thermometer is proposed. In this method, a substrate is placed on a stage, and the temperature of the substrate is measured using an infrared thermometer via a through hole formed in a target which is set to face the substrate, while heating the substrate. With this method, an infrared radiation emissivity of the substrate at a specific temperature is measured in advance using a calibration sample, the substrate temperature during deposition is measured with reference to that measured value, and temperature control is executed using the measurement result.

However, it is difficult for the measurement method using the infrared thermometer to cope with larger substrate sizes. For example, in case of a flat-panel display and thin-film solar cell, devices having required performances have to be integrated on a large-area substrate exceeding 1 m². When a lamp heater is set at only one position, it cannot uniformly heat the large-area substrate. For this reason, in order to uniformly heat the large-area substrate, lamp heaters have to be set at a plurality of positions. In order to attain accurate temperature measurement of the large-area substrate, the temperatures have to be measured while moving an infrared thermometer. However, such arrangement results in a problem of a complicated apparatus.

In a conventionally used apparatus which heats a substrate, the temperature of a portion of the large-area substrate is measured, and all lamp heaters undergo heating control based on that measurement result. In this case, the temperature control is executed without accurately measuring the overall temperatures of the large-area substrate. For this reason, it is difficult for a large-area substrate to attain deposition with well-controlled film quality.

### SUMMARY OF THE INVENTION

The present invention has been made in consideration of the aforementioned problems, and provides a substrate processing technique which accurately measures temperatures of an overall substrate in vacuum, and can attain temperature distribution management required to give a uniform temperature distribution on the entire surface of a substrate, and temperature control of the substrate based on the measurement result.

According to one aspect of the present invention, there is provided a substrate processing apparatus having a first process chamber, a second process chamber, and a convey unit used to convey a substrate, comprising:

a heating unit configured to have a plurality of heaters used to heat the substrate in the first process chamber;

a temperature line sensor configured to measure temperatures of the substrate heated by the heating unit while the substrate is conveyed from the first process chamber to the second process chamber using the convey unit;

a re-heating unit configured to have a plurality of heaters used to re-heat the substrate in the second process chamber; and

a first output control unit configured to control an output of the re-heating unit based on measurement results of the temperature line sensor.

According to another aspect of the present invention, there is provided a deposition method for depositing a film on a substrate using a substrate processing apparatus which has a first process chamber, a second process chamber, and a convey unit used to convey the substrate, the method comprising steps of:

heating the substrate using a plurality of heaters in the first process chamber;

measuring temperatures of the heated substrate using a temperature line sensor while the substrate is conveyed from the first process chamber to the second process chamber using the convey unit;

re-heating the substrate using a plurality of heaters used to re-heat the substrate in the second process chamber based on measuring results in the measurement step; and

depositing a film on the substrate re-heated in the re-heating step in the second process chamber.

According to the present invention, a substrate processing technique which accurately measures temperatures of the overall substrate in vacuum, and can attain temperature distribution management required to give a uniform temperature distribution on the entire surface of a substrate and temperature control of the substrate based on the measurement result can be provided.

The present invention provides a substrate processing apparatus which can attain accurate temperature control of a substrate, and is applied to a deposition apparatus to attain temperature distribution management and temperature control based on the accurate temperature measurement, thus allowing formation of high-quality films.

Further features of the present invention will become apparent from the following description of exemplary embodiments with reference to the attached drawings.

### BRIEF DESCRIPTION OF THE DRAWINGS

FIG. 1 is a schematic plan view showing the arrangement of a vacuum processing/deposition apparatus according to an embodiment of the present invention;

FIG. 2 is a sectional view of a heating chamber 2 and deposition chamber 3 included in the vacuum processing/deposition apparatus;

FIG. 3 is a view showing a modification of the layout of lamp heaters 5 in the deposition chamber 3;

FIG. 4 is a flowchart for explaining the sequence of operations of the vacuum processing/deposition apparatus according to the embodiment of the present invention;

FIG. 5 is a block diagram showing the functional arrangement of a controller 201; and

FIG. 6 is a view showing an example of a substrate temperature map 601.

### DESCRIPTION OF THE EMBODIMENTS

Preferred embodiments of the present invention will be exemplarily described in detail hereinafter with reference to the drawings. However, components described in these embodiments are merely examples, and the technical scope of the present invention is settled by the scope of the claims but it is not limited by the following individual embodiments.

(Arrangement of Vacuum Processing/Deposition Apparatus)

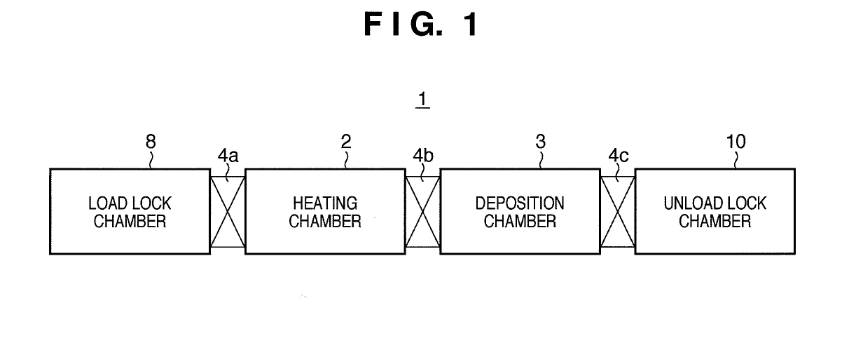

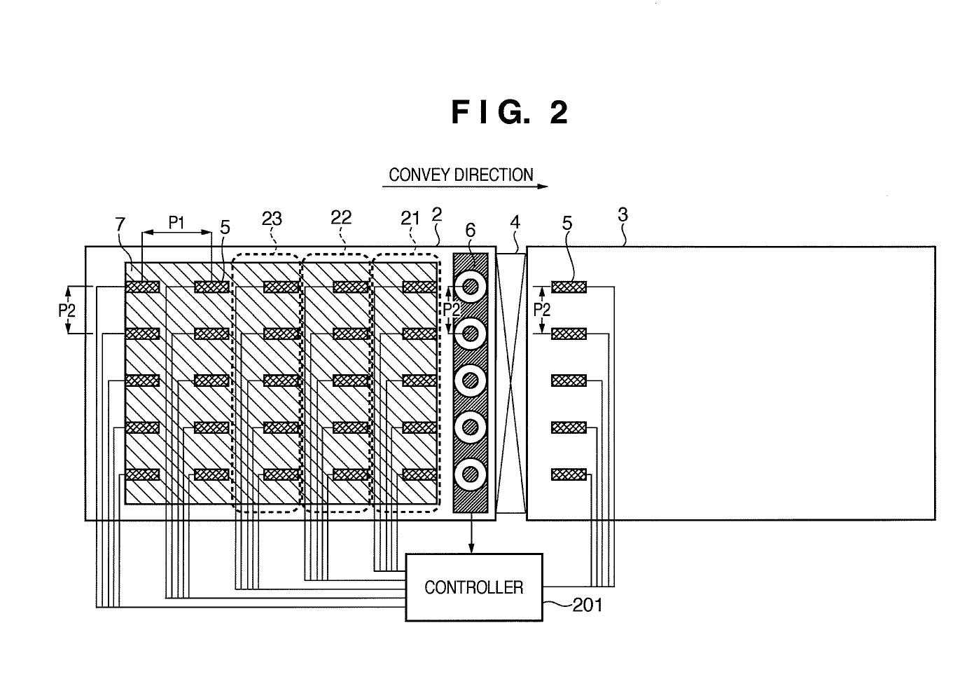

FIG. 1 is a schematic plan view showing the arrangement of a vacuum processing/deposition apparatus 1 (to be also referred to as a “substrate processing apparatus” hereinafter) according to an embodiment of the present invention. FIG. 2 is a sectional view showing a heating chamber 2 (first process chamber) and a deposition chamber 3 (second process chamber) included in the vacuum processing/deposition apparatus 1. A gate valve 4a is arranged between a load lock chamber 8 and the heating chamber 2, and a gate valve 4b is arranged between the heating chamber 2 and deposition chamber 3. A gate valve 4c is arranged between the deposition chamber 3 and an unload lock chamber 10. By opening the gate valve 4a, the load lock chamber 8 and heating chamber 2 communicate with each other. By opening the gate valve 4b, the heating chamber 2 and deposition chamber 3 communicate with each other. By opening the gate valve 4c, the deposition chamber 3 and unload lock chamber 10 communicate with each other. By closing the gate valves 4a, 4b, and 4c, the load lock chamber 8, heating chamber 2, deposition chamber 3, and unload lock chamber 10 respectively become independent chambers.

To the load lock chamber 8, heating chamber 2, and deposition chamber 3, an evacuation system (not shown) is connected to maintain the interiors of these chambers in a predetermined vacuum state. The deposition chamber 3 includes a plasma generation mechanism (not shown) which introduces a process gas, and generates a plasma by predetermined discharging.

In the heating chamber 2 (first process chamber), reference numeral 5 denotes lamp heaters serving as a heating unit. In the deposition chamber 3 (second process chamber), the lamp heaters 5 serve as a re-heating unit.

The lamp heaters 5 in the heating chamber 2 (first process chamber) are arranged for N columns (N is a natural number; five columns in case of FIG. 2) at intervals of a pitch P1 (first interval) in the convey direction of a substrate (first direction), so as to uniformly heat the entire surface of a substrate 7. The lamp heaters 5 are arranged for M rows (M is a natural number; five rows in case of FIG. 2) at intervals of a pitch P2 (second interval) in a direction (second direction) perpendicular to the convey direction of the substrate 7. The lamp heaters 5 are laid out in a matrix of M rows×N columns, and are used to heat the substrate 7.

Reference numeral 6 denotes an infrared radiation thermometer serving as a temperature measurement unit. A plurality of infrared radiation thermometers 6 are arranged at the same pitch as the interval of the pitch P2 in the direction (second direction) perpendicular to the convey direction of the substrate 7.

The substrate 7 is conveyed between the heating chamber 2 and deposition chamber 3 by a convey mechanism (not shown). The plurality of infrared radiation thermometers 6 are arranged on a convey path of the substrate 7, and measure irradiance intensities from the substrate 7 heated by the lamp heaters 5 while the substrate 7 is conveyed from the heating chamber 2 to the deposition chamber 3. Note that the infrared radiation thermometers 6 are arranged linearly. In such case, a group of the infrared radiation thermometers 6 will also be referred to as a temperature line sensor.

Prior to deposition, a substrate temperature map is generated so as to confirm uniformity of the substrate temperatures heated by the lamp heaters in the heating chamber 2. For example, when the lamp heaters are arranged to form five columns, as shown in FIG. 2, five substrates 7 are prepared, and temperature measurements are carried out as follows. The first substrate 7 is carried into the heating chamber 2, and is heated by turning on only a first lamp heater column 21. When the substrate 7 is conveyed to the deposition chamber by the convey mechanism after heating for a predetermined time period, the infrared radiation thermometers 6 respectively measure irradiance intensities from the substrate 7 heated by the first lamp heater column 21. Letting D be a distance between the center of the infrared radiation thermometers 6 and the substrate end portion on the deposition chamber side, and V be a convey velocity of the substrate, the temperature measurement is started after an elapse of D/V from the beginning of conveying to the deposition chamber. Letting L be the length of the substrate in the convey direction, a measurement time is L/5V. Average values of the measurement results are set as temperatures of a range of L/5 from the substrate end immediately above the first lamp heater column 21. Next, the second substrate 7 is carried into the heating chamber 2, and is heated by turning on only a second lamp heater column 22. After heating for the same predetermined time period as that for the first substrate, the substrate is conveyed into the deposition chamber. After an elapse of D/V+L/5V from the beginning of conveying into the deposition chamber, the temperature measurement is started. A measurement time is L/5V. Average values of the measurement results are set as temperatures within a range from L/5V to 2L/5V from the substrate end. The third substrate 7 is then carried into the heating chamber 2, and is heated by turning on only a third lamp heater column 23. After heating for the same predetermined time period as that for the first substrate, the substrate is conveyed into the deposition chamber. After an elapse of D/V+2L/5V from the beginning of conveying into the deposition chamber, the temperature measurement is started. A measurement time is L/5V. Average values of the measurement results are set as temperatures within a range from 2L/5V to 3L/5V from the substrate end. Likewise, the temperatures of the substrates 7 heated by the corresponding lamp heater columns are respectively measured by the infrared radiation thermometers 6. When one lamp heater column includes five lamp heaters 5, the 25 measurement results of irradiance intensities are obtained by measurements for the five lamp heater columns. The measurement results are input to a controller 201 serving as a control unit.

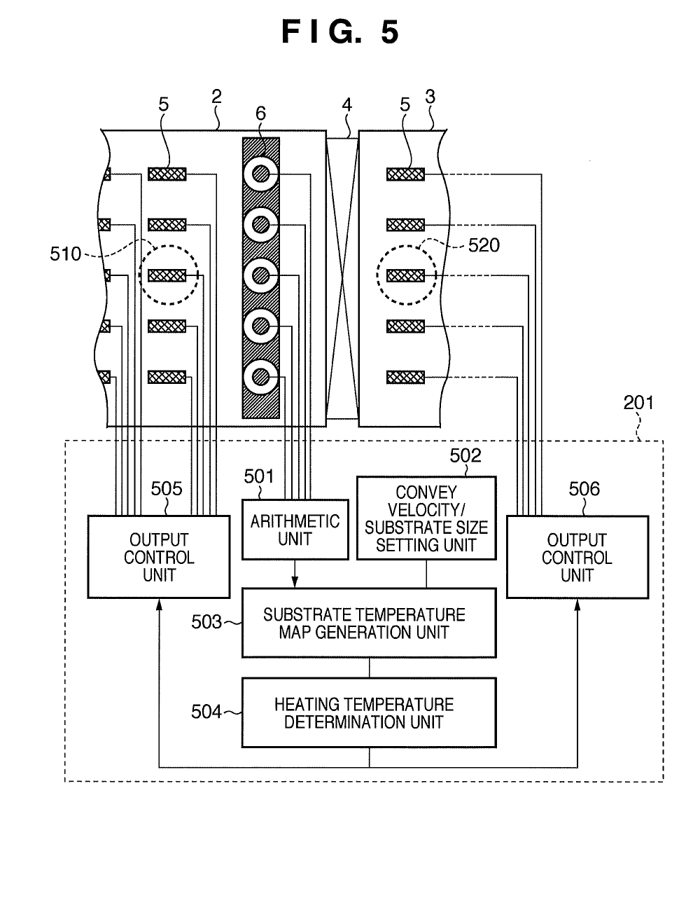

FIG. 5 is a block diagram showing the functional arrangement of the controller 201. The measurement results of irradiance intensities are sequentially input to an arithmetic unit 501. The arithmetic unit 501 calculates in-plane temperatures of the substrate 7 based on the input measurement results of irradiance intensities using the radiation factor of the substrate, which is measured in advance.

A convey velocity/substrate size setting unit 502 is a processing unit which sets the convey velocity of the convey mechanism and the size of the substrate 7.

A substrate temperature map generation unit 503 calculates temperature measurement positions on the substrate 7 based on the temperature measurement timings by the infrared radiation thermometers 6, which are measured by the arithmetic unit 501, and the convey velocity and the size of the substrate 7, which are set by the convey velocity/substrate size setting unit 502.

The substrate temperature map generation unit 503 specifies the infrared radiation thermometers 6, which are to be used in the measurement in each lamp heater column based on the set size of the substrate 7, and output valid measurement data. For example, in case of a large-area substrate, the substrate temperature map generation unit 503 uses, as valid measurement data, all the measurement results (five results in case of FIG. 2) of the infrared radiation thermometers 6. On the other hand, in case of a small substrate, the substrate temperature map generation unit 503 uses the three central infrared radiation thermometers 6.

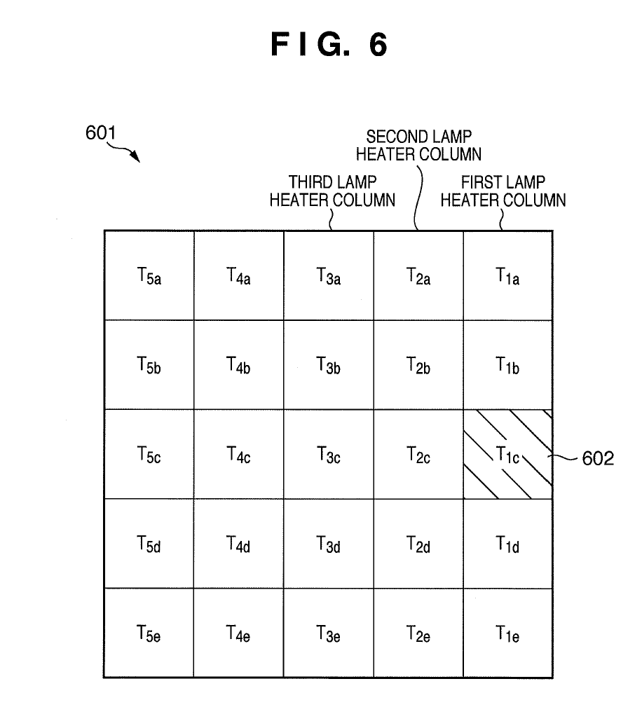

The substrate temperature map generation unit 503 generates a substrate temperature map (FIG. 6), which indicates the temperature distribution of the substrate 7, by associating the temperature measurement positions on the substrate 7, the set size of the substrate 7, and the temperatures calculated by the arithmetic unit 501.

FIG. 6 is a view showing an example of a substrate temperature map 601. A temperature distribution of the substrate 7 heated by the first lamp heater column 21 is defined by temperatures T1a, T1b, T1c, T1d, and T1e. A temperature distribution of the substrate 7 heated by the second lamp heater column 22 is defined by temperatures T2a, T2b, T2c, T2d, and T2e. Likewise, a temperature distribution of the substrate 7 heated by the third lamp heater column 23 is defined by temperatures T3a, T3b, T3c, T3d, and T3e. The substrate temperature map 601 has a data structure in a matrix pattern, and the temperature distribution of the substrate 7 can be grasped with reference to the substrate temperature map 601.

A heating temperature determination unit 504 determines whether or not a difference between a predetermined reference temperature and each temperature stored in the reference temperature map 601 falls within a predetermined error range. That is, the heating temperature determination unit 504 determines, with reference to the substrate temperature map 601, whether or not there is a heating position corresponding to a heating temperature of the substrate 7 lower than the predetermined reference temperature, or whether or not there is a heating position corresponding to a heating temperature relatively lower than other heating positions. Also, the heating temperature determination unit 504 determines whether or not there is a heating position corresponding to a heating temperature relatively higher than other heating positions.

An output control unit 505 (second output control unit) controls the heating temperatures of the lamp heaters 5 arranged in the heating chamber 2 based on the determination result of the heating temperature determination unit 504, so as to raise the heating temperature of the lamp heater which corresponds to a heating position corresponding to a heating temperature lower than the reference temperature or a heating position corresponding to a heating temperature relatively lower than other heating positions. In the example shown in FIG. 6, when the heating temperature determination unit 504 determines that a temperature T1c 602 of the substrate temperature map 601 is lower than the reference temperature, the output control unit 505 specifies a lamp heater 510 (FIG. 5) corresponding to the temperature measurement position of the temperature T1c, and controls to raise the heater output of the lamp heater 510.

Alternatively, the heating condition settings may be changed, so that the output control unit 505 controls to lower the heating temperature of a lamp heater corresponding to a heating position corresponding to a heating temperature relatively higher than other heating positions.

The individual output settings of the lamp heaters 5 arranged in the heating chamber 2 can be changed under the control of the output control unit 505 based on the substrate temperature map 601, thereby obtaining a uniform temperature distribution of a next substrate 7 to be heated.

An output control unit 506 (first output control unit) controls the operations of the lamp heaters 5 (FIGS. 2 and 5) arranged in the deposition chamber 3 based on the determination result of the heating temperature determination unit 504, so as to raise a temperature of a heating position corresponding to a heating temperature lower than the reference temperature or a heating position corresponding to a heating temperature relatively lower than other heating positions. The output control unit 506 controls to operate a corresponding heater of the lamp heaters 5 (re-heating unit) arranged in the deposition chamber 3, so as to re-heat a lower temperature position beyond the error range, based on the determination result of the heating temperature determination unit 504.

When the substrate 7 is conveyed into the deposition chamber 3, and passes under the lamp heaters 5, the lamp heater 5, which corresponds to a heating position where the reference temperature is not reached or a heating position corresponding to a heating temperature relatively lower than other heating positions, is turned on for a predetermined time period to heat the substrate 7. The ON control of the lamp heater 5 by the output control unit 506 upon heating the substrate up to the reference temperature compensates for a difference calculated by (the reference temperature—the temperature T1c in the substrate temperature map 601).

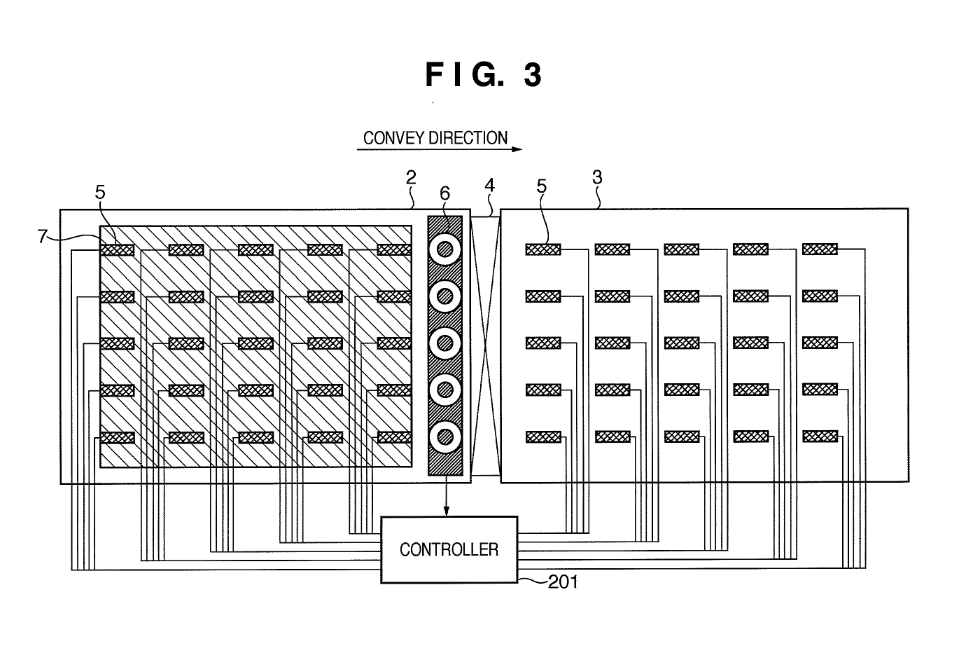

The arrangement of the lamp heaters 5 arranged in the deposition chamber 3 is not limited to the example shown in FIGS. 2 and 5. For example, the lamp heaters 5 may be arranged to have predetermined intervals as in the heating chamber 2, as shown in FIG. 3. In case of FIG. 3, when the substrate 7 is housed in the deposition chamber 3, the output control unit 506 can control to selectively heat a lower temperature position using the lamp heaters 5.

By re-heating the substrate 7 using the lamp heaters 5 under the control of the output control unit 506, a uniform in-plane temperature distribution of the substrate 7 can be obtained.

(Deposition Method Using Vacuum Processing/Deposition Apparatus)

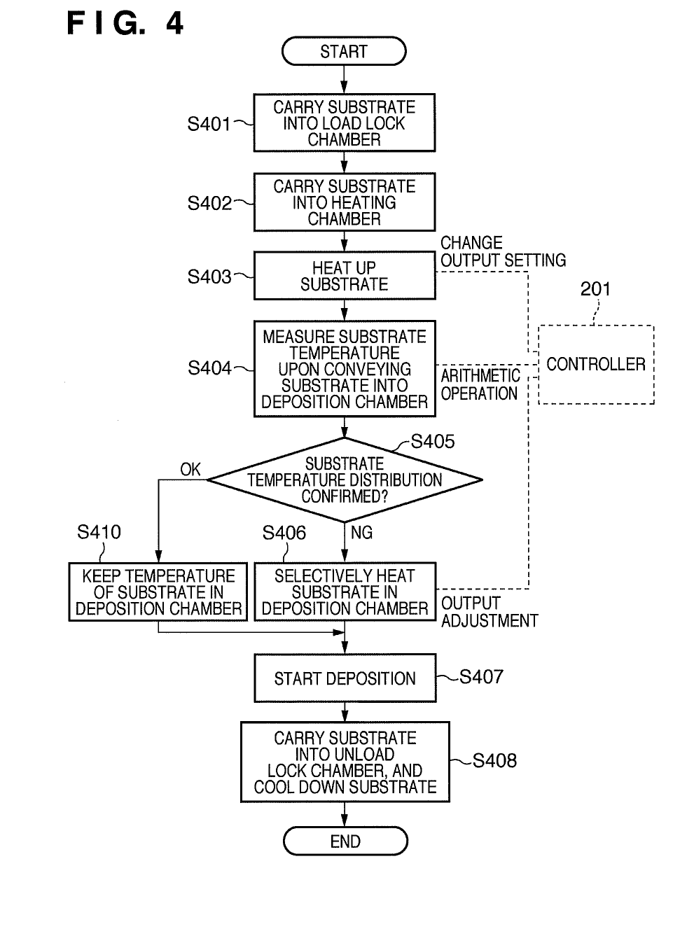

FIG. 4 is a flowchart for explaining the sequence of operations of the vacuum processing/deposition apparatus 1 according to the embodiment of the present invention.

In step S401, the substrate 7 is carried into the load lock chamber 8 by a convey mechanism (not shown). In step S402, the substrate 7 is carried into the heating chamber 2 by the convey mechanism (not shown). In step S403, the output control unit 505 controls to heat the substrate 7 by the lamp heaters 5 arranged in the heating chamber 2. The output control unit 505 of the controller 201 changes the individual output settings of the lamp heaters 5 arranged in the heating chamber 2 based on the substrate temperature map 601, thus obtaining a uniform temperature distribution of the substrate 7 to be heated.

In step S404, the infrared radiation thermometers 6 measure the substrate temperatures when the heated substrate 7 is conveyed to the deposition chamber 3. The substrate temperature map generation unit 503 of the controller 201 makes arithmetic operations for associating the temperature measurement positions on the substrate 7, the set size of the substrate 7, and the temperatures calculated by the arithmetic unit 501, thereby generating a substrate temperature map indicating the substrate temperature distribution of the substrate 7.

In step S405, the temperature distribution is confirmed. The heating temperature determination unit 504 determines, with reference to the substrate temperature map 601, whether or not there is a heating position of the substrate 7 corresponding to a heating temperature lower than the reference temperature, or whether or not there is a heating position corresponding to a heating temperature relatively lower than other heating positions. Also, the heating temperature determination unit 504 determines whether or not there is a heating position corresponding to a heating temperature relatively higher than other heating positions. If the temperature distribution of the substrate 7 exceeds the predetermined error range with respect to the reference temperature, the heating temperature determination unit 504 determines “NG”, and the process advances to step S406.

In step S406, the substrate 7 is selectively heated (re-heated) in the deposition chamber 3. The output control unit 506 executes output adjustment of the respective lamp heaters 5 arranged in the deposition chamber 3, and controls the operations of the lamp heaters so as to raise a temperature of a heating position corresponding to a temperature lower than the reference temperature or a heating position corresponding to a heating temperature relatively lower than other heating positions.

On the other hand, if it is determined in step S405 that the temperature distribution of the substrate 7 falls within the predetermined error range with respect to the reference temperature, the heating temperature determination unit 504 determines “OK”, and the process advances to step S410. In step S410, the temperature of the substrate 7 is kept in the deposition chamber 3 until deposition processing starts. In step S407, the deposition processing for the substrate 7 starts.

In step S408, the substrate 7 which has undergone the deposition processing is carried from the deposition chamber 3 into the unload lock chamber 10, and is cooled down for a predetermined time period. The cooled substrate is unloaded from the unload lock chamber 10, thus ending a series of processes of the substrate processing apparatus.

Note that in the case that light of each lamp heater may often enter the infrared radiation thermometer as stray light, for example, a thermometer which is not influenced by the lamp heaters, that is, the infrared radiation thermometer having a measurement wavelength which is different from the radiation wavelength of the lamp heater, is preferably used.

(Manufacturing Method of Electronic Device Using Vacuum Processing/Deposition Apparatus)

The aforementioned vacuum processing/deposition apparatus 1 can be provided to manufacturing methods of an electronic device, for example, substrates for a flat-panel display and thin-film solar cell, and other semiconductor devices.

According to this embodiment, the temperatures of the entire substrate are accurately measured in vacuum, and the temperature distribution management required to give a uniform temperature distribution on the entire surface of the substrate, and the temperature control of the substrate can be attained based on the measurement result.

The substrate processing apparatus, which can execute accurate temperature control of a substrate, can be provided, and execute the temperature distribution control and temperature control based on the accurate temperature measurement by applying that apparatus to a deposition apparatus, thus allowing formation of high-quality films.

For example, when films are to be deposited on a substrate by a sputtering method, energy losses of sputtering atoms that have reached the substrate are different depending on the magnitudes of heat energies based on the substrate temperature. Hence, in order to form a high-density film, it is important to control the substrate temperature. A surface diffusion becomes larger with increasing energy of sputtering atoms that have reached the substrate, and a high-density film can be obtained by the incidence of the sputtering atoms of the increased energy. And furthermore, to suppress the loss of the sputtering atoms which reach the substrate during a migration, the temperature should be kept at a pertinent temperature. Therefore, it is critically important to keep the substrate temperature at the pertinent temperature to obtain the high-density film. Especially, since a refractory metal material has a large substrate temperature dependence, the substrate processing apparatus according to this embodiment controls the substrate temperature before deposition by the temperature distribution management based on the accurate temperature measurement, thus allowing formation of a high-density film.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-335156, filed Dec. 26, 2008, Japanese Patent Application No. 2009-283428, filed Dec. 14, 2009, which are hereby incorporated by reference herein in their entirety.

What is claimed is:

1. A substrate processing apparatus having a first process chamber, a second process chamber, and a convey unit used to convey a substrate, comprising:
a heating unit configured to have a plurality of heaters used to heat the substrate in the first process chamber;
a temperature line sensor configured to measure temperatures of the substrate heated by said heating unit while the substrate is conveyed from the first process chamber to the second process chamber using the convey unit;
a re-heating unit configured to have a plurality of heaters used to re-heat the substrate in the second process chamber; and
a first output control unit configured to control an output of said re-heating unit based on measurement results of said temperature line sensor.

2. The apparatus according to claim 1, further comprising a second output control unit configured to control an output of said heating unit based on the measurement results of said temperature line sensor.

3. The apparatus according to claim 1, further comprising:
a substrate temperature map generation unit configured to generate a substrate temperature map, which indicates a temperature distribution of the substrate, by associating temperature measurement positions of the substrate, which are calculated based on a convey velocity of the convey unit and a size of the substrate, which are set in advance, and
temperatures based on the measurement results of said temperature line sensor; and
a heating temperature determination unit configured to determine whether or not a difference between a predetermined reference temperature and each temperature stored in the substrate temperature map falls within a predetermined error range.

4. The apparatus according to claim 3, wherein said first output control unit controls to operate the corresponding heater of said re-heating unit so as to re-heat a position where a temperature is lower beyond the error range based on a determination result of said heating temperature determination unit.

5. The apparatus according to claim 3, wherein said second output control unit controls an output the heater of said heating unit corresponding to a position where a temperature is lower or higher beyond the error range based on a determination result of said heating temperature determination unit.

6. The apparatus according to claim 1, wherein the plurality of heaters of said heating unit are arranged at first intervals along a convey direction of the substrate, and are arranged at second intervals along a direction perpendicular to the convey direction.

7. The apparatus according to claim 6, wherein respective measurement units which configure said temperature line sensor are arranged at the second intervals along the direction perpendicular to the convey direction.

8. The apparatus according to claim 6, wherein the plurality of heaters of said re-heating unit are arranged at the second intervals along the direction perpendicular to the convey direction.

9. The apparatus according to claim 1, wherein the plurality of heaters of said re-heating unit are arranged at first intervals along a convey direction of the substrate, and are arranged at second intervals along a direction perpendicular to the convey direction.

10. A deposition method for depositing a film on a substrate using a substrate processing apparatus which has a first process chamber, a second process chamber, and a convey unit used to convey the substrate, the method comprising steps of:
heating the substrate using a plurality of heaters in the first process chamber;
measuring temperatures of the heated substrate using a temperature line sensor while the substrate is conveyed from the first process chamber to the second process chamber using the convey unit;
re-heating the substrate using a plurality of heaters used to re-heat the substrate in the second process chamber based on measuring results in the measurement step; and
depositing a film on the substrate re-heated in the re-heating step in the second process chamber.

11. An electronic device manufacturing method, comprising:
a step of processing a substrate using a substrate processing apparatus according to claim 1.
